(19) United States
(12) Patent Application Publication
(10) Pub. No.: US 2005/0254445 A1
(43) Pub. Date: Nov. 17, 2005

(54) Receiver and method of operation thereof

(76) Inventors: David H. Evans, Crawley (GB); Bhavin S. Khatri, London (GB); Deborah L. Raynes, Horley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/510,259

(22) PCT Filed: Feb. 28, 2003
(86) PCT No.: PCT/IB03/00828

§ 371 Date: Oct. 5, 2004

(51) Int. Cl. H04J 1/10; H04J 3/08; H04B 7/14

(52) U.S. Cl. 370/315

(57) ABSTRACT

A receiver comprises a plurality of antennas (108) for receiving signals originally transmitted as a plurality of different signals, for example from a MIMO (Multi-Input Multi-Output) transmitter. The receiver includes a plurality of coders (302) for applying a respective unique code to each received signal and a summer (306) for combining the coded signals into a single signal which is then down-converted by a single frequency translation stage (202) and digitised. An output signal corresponding to each received signal is obtained by a plurality of detectors (312) with reference to the codes used by the coders. In a preferred embodiment, the unique codes are orthogonal codes such as Walsh codes. The receiver enables a single frequency translation stage to be used to process a plurality of received signals, thereby both saving hardware and reducing the receiver's power consumption.

### TECHNICAL FIELD

The present invention relates to a receiver for receiving signals originally transmitted as a plurality of different signals, and to a method of operating the receiver.

### BACKGROUND ART

In a typical communication system, radio signals travel from a transmitter to a receiver via a plurality of paths, each involving reflections from one or more scatterers. Received signals from the paths may interfere constructively or destructively at the receiver (resulting in position-dependent fading). Further, differing lengths of the paths, and hence the time taken for a signal to travel from the transmitter to the receiver, may cause inter-symbol interference.

It is possible to take advantage of such a situation by the use of multiple antennas at both transmitter and receiver, enabling a plurality of different signals to be transmitted on the same frequency at the same time. Such a system is known as a Multi-Input Multi-Output (MIMO) system, whereby a data stream for transmission is split into a plurality of sub-streams, each of which is sent via many different paths. One example of such a system is described in U.S. Pat. No. 6,067,290, another example, known as the BLAST system, is described in the paper “V-BLAST: an architecture for realising very high data rates over the rich-scattering wireless channel” by P W Wolniansky et al in the published papers of the 1998 URSI International Symposium on Signals, Systems and Electronics, Pisa, Italy, 29 Sep. to 2 Oct. 1998.

In BLAST each sub-stream is sent to a single antenna. In alternative systems each sub-stream can be mapped to a different spatial direction using antenna beam-forming techniques. An example of a MIMO system with dynamically changing beam directions is disclosed in our co-pending unpublished International patent application WO 02/061969 (Applicant's reference PHGB010012).

Typically in a MIMO system the original data stream is split into N sub-streams, each of which is transmitted by a different antenna of an array having n_{T}=N elements. A similar array having n_{R}≧N elements is used to receive signals, each antenna of the array receiving a different superposition of the N sub-streams. Using these differences, together with knowledge of the channel transfer matrix, the sub-streams can be separated and recombined to yield the original data stream. In some circumstances it is possible for n_{R} to be less than N, in particular in a wideband channel when a plurality of substantially uncorrelated signal samples may be determined from each received signal. Further details are disclosed in our co-pending International patent application PCT/IB02/02439 (Applicant's reference PHGB010100).

The performance gains which may be achieved from a MIMO system may be used to increase the total data rate at a given error rate, or to reduce the error rate for a given data rate, or some combination of the two. A MIMO system can also be controlled to reduce the total transmitted energy or power for a given data rate and error rate. In theory, the capacity of the communications channel increases linearly with the smaller of the number of antennas on the transmitter or the receiver. However, a more useful way to view a MIMO system is that the capacity of the channel is limited by the number of statistically independent paths between the transmitter and receiver, caused by scatterers in the environment.

When designing a receiver for use in a MIMO system, significant extra expense is caused by the need for a separate RF (Radio Frequency) section, for each antenna to translate received signals from RF to base band. This requirement is in order to preserve spatial information from the antenna array for subsequent processing to extract the sub-streams. One way in which the requirement for a plurality of RF sections can be avoided is by applying a different frequency offset to the signal from each antenna, after which a single frequency translation is performed and the individual signals can be recovered after digitisation. Such a technique is disclosed in our co-pending International patent application PCT/IB02/02410 (Applicant's reference PHGB010199). However, a receiver implementing this technique still requires additional local oscillators in order to generate the required frequency offsets.

### DISCLOSURE OF INVENTION

An object of the present invention is to provide a receiver for a MIMO system comprising a single RF section for down-conversion of received signals to base band.

According to a first aspect of the present invention there is provided a receiver comprising a plurality of antennas for receiving signals originally transmitted as a plurality of different signals, coding means for applying a respective unique code to the signal received by each antenna, summing means for combining the plurality of coded signals into a single signal, frequency translation means for translating the frequency of the single signal to a lower frequency and extraction means for extracting a plurality of signals from the frequency-translated single signal by reference to the unique codes employed by the coding means.

Application of the respective unique codes to each received signal enables a single frequency translation stage to be used to process a plurality of received signals, thereby both saving hardware and reducing the receiver's power consumption. In a preferred embodiment, the unique codes are orthogonal codes such as Walsh codes. The rate of the unique codes would typically need to be at least N times the symbol rate of the received signals, where N is equal to the number of antennas.

According to a second aspect of the present invention there is provided a method of operating a receiver comprising a plurality of antennas for receiving signals originally transmitted as a plurality of different signals, the method comprising applying a respective unique code to the signal received by each antenna, combining the plurality of coded signals into a single signal, translating the frequency of the single signal to a lower frequency and extracting a plurality of signals from the frequency-translated single signal by reference to the unique codes used to generate the coded signals.

Combining of orthogonally-coded signals for processing by a single frequency translation stage is know from U.S. patent application US 2001/0022822. However, the receiver disclosed therein is solely applicable to reception of signals originating as a single signal. Furthermore, the orthogonal coding is applied to ensure that, once summed, the individual signals do not need to be recovered, and indeed should not be recovered. This is because the properties of the orthogonal code are claimed to ensure that the energy of the summed signal can never be zero, unlike in a conventional diversity receiver.

By means of the present invention it is possible to build a MIMO receiver having significantly reduced hardware costs compared to known receivers.

### BRIEF DESCRIPTION OF DRAWINGS

Embodiments of the present invention will now be described, by way of example, with reference to the accompanying drawings, wherein:

FIG. 1 is a block schematic diagram of a known MIMO radio system;

FIG. 2 is a block schematic diagram of a part of a known MIMO receiver;

FIG. 3 is a block schematic diagram of part of a MIMO receiver made in accordance with the present invention; and

FIG. 4 is a flow chart illustrating a method of operation of a MIMO receiver made in accordance with the present invention.

In the drawings the same reference numerals have been used to indicate corresponding features.

### MODES FOR CARRYING OUT THE INVENTION

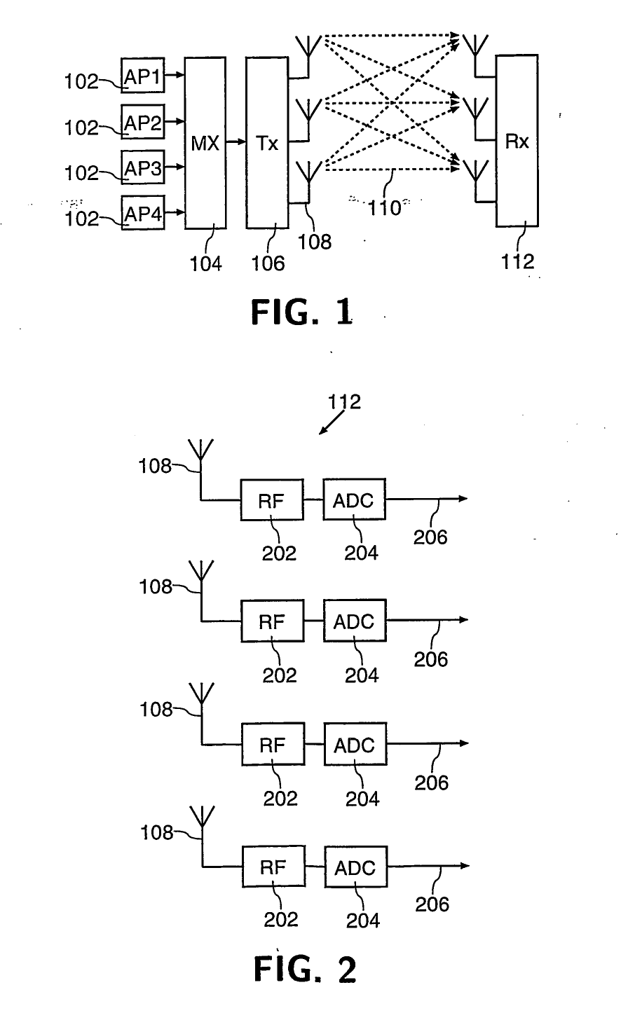

FIG. 1 illustrates a known MIMO radio system. A plurality of applications 102 (AP1 to AP4) generate data streams for transmission. An application 102 could also generate a plurality of data streams. The data streams are combined by a multiplexer (MX) 104 into a single data stream, which is supplied to a transmitter (Tx) 106. The transmitter 106 separates the data stream into sub-streams and maps each sub-stream to one or more of a plurality of transmit antennas 108.

Suitable coding, typically including Forward Error Correction (FEC), may be applied by the transmitter 106 before multiplexing. This is known as vertical coding, and has the advantage that coding is applied across all sub-streams. However, problems may arise in extracting the sub-streams since joint decoding is needed and it is difficult to extract each sub-stream individually. As an alternative each sub-stream may be coded separately, a technique known as horizontal coding which may simplify receiver operation. These techniques are discussed for example in the paper “Effects of Iterative Detection and Decoding on the Performance of BLAST” by X Li et al in the Proceedings of the IEEE Globecom 2000 Conference, San Francisco, Nov. 27 to Dec. 1, 2000.

If vertical coding is used the FEC which is applied must have sufficient error-correcting ability to cope with the entire MIMO channel, which comprises a plurality of paths 110. For simplicity of illustration only direct paths 110 between antennas 108 are illustrated, but it will be appreciated that the set of paths will typically include indirect paths where signals are reflected by one or more scatterers.

A receiver (Rx) 112, also provided with a plurality of antennas 108, receives signals from the multiple paths. Each of the resultant plurality of signals has its frequency translated to base band, to enable the signals to be combined, decoded and demultiplexed to provide respective data streams to each application. Although both the transmitter 110 and receiver 112 are shown as having the same number of antennas, this is not necessary in practice and the numbers of antennas can be optimised depending on space and capacity constraints. Similarly, the transmitter 106 may support any number of applications (for example, a single application on a voice-only mobile telephone or a large number of applications on a PDA).

FIG. 2 is a block diagram of the initial stages of a receiver 112. Each antenna has an associated RF section 202, which translates (down-converts) the frequency of the received signal to base band where it can be processed. Typically, the base band signals are converted into the digital domain by an analogue to digital converter (ADC) 204 and the digitised signals provided as outputs 206 for further processing to extract the transmitted sub-streams. This requirement for one RF section per antenna is to preserve the properties of the received signals for the further processing, but it leads to duplication of components, and hence to extra cost and power consumption.

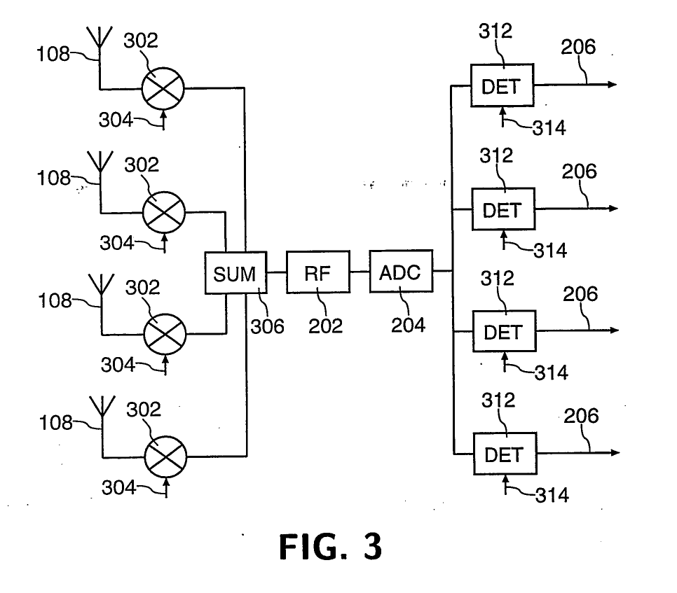

FIG. 3 is a block schematic diagram of the initial stages of a MIMO receiver made in accordance with the present invention which addresses this problem. The illustrated receiver comprises four antennas 108. The received signal from each antenna 108 is passed through a respective BPSK (Binary Phase Shift Keying) phase modulator 302 which encodes the signal with an unique code supplied via a respective input 304. The signals are then combined into a single signal by a summation block 306 and down-converted to base band by a single conventional RF section 202.

The base band signal is converted into the digital domain by an analogue to digital converter 204. The digitised signal is then processed by four detectors (DET) 312, each of which is supplied with a respective reference code on an input 314. These reference codes are related to the unique codes supplied to the modulators 302, the properties of which enable extraction by each detector 312 of a base band signal corresponding to a signal received by a respective one of the antennas 108. The extracted base band signal is supplied as an output 206 for further processing by MIMO circuitry.

Instead of a single analogue to digital converter 204, as shown in FIG. 3, the recovered signals 206 could be digitised by a plurality of ADCs. Although this involves some hardware duplication, there are some advantages. Firstly the ADCs can run at a lower sampling rate and dynamic range, and can hence have a lower power consumption. Secondly, the filters required before the ADCs correspond to the actual channel bandwidth, while the channel filter required in the receiver shown in FIG. 3 need to have a bandwidth of N times the channel bandwidth, to allow for the increased bandwidth generated by the unique codes.

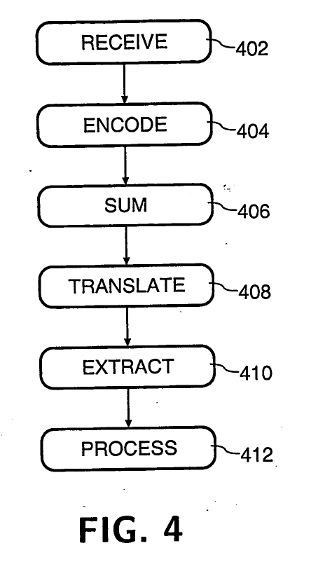

The sequence of operations described above is summarised by the flow chart shown in FIG. 4. Step 402 corresponds to a plurality of signals being received; step 404 to each of these signals being encoded with a unique code; step 406 to the encoded signals being summed to form a single signal; step 408 to the frequency of the single signal being translated; step 410 to a plurality of signals being extracted from the the single signal; and step 412 to the plurality of signals being processed by MIMO circuitry.

The unique codes may for example be pseudo random sequences having low cross correlation. However, in a preferred embodiment of the present invention the unique codes are orthogonal codes such as a set of Walsh functions. The modulators 302 apply these codes to the analogue signals from the antennas by direct modulation. This may be done using BPSK, as in the example of FIG. 3, but it will be apparent that a range of other known modulation schemes could equally well be used. The rate of the orthogonal code should be greater than the symbol period of the received signals to enable extraction of the individual components of the received signals by the detectors 312. For example the application of the Walsh functions wal(0,θ) (given by the sequence 1, 1) and wal(1,θ) (given by the sequence 1, −1) to the combined signal from a pair of antennas should be performed at twice the basic sample rate. As a general rule, if there are N antennas the rate for the orthogonal code should be at least N times the basic sample rate.

The detectors 312 would typically be correlators, although in its simplest form the extraction process simply requires the multiplication of the digitised signal by each Walsh function. For the two antenna example used above, this requires two multiplications (one for each element of the Walsh function) and a summation of the two resultant samples to extract each of the originally received signals.

Since the orthogonal codes are applied within the receiver, there should be little or synchronisation issues between the BPSK modulators 302 and the timing in the detectors 312. Also, there is no need for any alignment between the unique codes and symbol periods in the received signals, provided that the rate of the unique code is sufficient to distinguish the N signals in a symbol period.

One problem with the MIMO receiver described above is that the increased bandwidth of the base band signals could result in an increase in adjacent channel interference. In situations where this is a problem, it can be addressed by encoding the adjacent channel interference is coded with the Walsh function wal(0,θ) (which is unity) and then not to use wal(0,θ) for the coding of the signals from the antennas. The interference will then be orthogonal to the desired signals and will be rejected by the detectors 312. A disadvantage of this approach is that an additional Walsh function will need to be used, which in the worst case will increase the bandwidth by a factor of 2N instead of N.

As well as its application to MIMO receivers, the present invention can be applied to any receiver where a plurality of signals originating from different sources require identical frequency translation (or other resource-intensive processing).

From reading the present disclosure, other modifications will be apparent to persons skilled in the art. Such modifications may involve other features which are already known in the design, manufacture and use of receivers and component parts thereof, and which may be used instead of or in addition to features already described herein.

In the present specification and claims the word “a” or “an” preceding an element does not exclude the presence of a plurality of such elements. Further, the word “comprising” does not exclude the presence of other elements or steps than those listed.

1. A receiver comprising a plurality of antennas for receiving signals originally transmitted as a plurality of different signals, coding means for applying a respective unique code to the signal received by each antenna, summing means for combining the plurality of coded signals into a single signal, frequency translation means for translating the frequency of the single signal to a lower frequency and extraction means for extracting a plurality of signals from the frequency-translated single signal by reference to the unique codes employed by the coding means.

2. A receiver as claimed in claim 1, characterised in that the respective unique codes are orthogonal codes.

3. A receiver as claimed in claim 2, characterised in that the respective unique codes are Walsh codes.

4. A receiver as claimed in claim 2 or 3, characterised in that the rate of the unique code is at least N times the symbol rate of the received signals, where N is equal to the number of antennas.

5. A receiver as claimed in claim 3, characterised in that the first Walsh code, wal(0,θ), is not used.

6. A receiver as claimed in any one of claims 1 to 5, characterised in the extraction means comprise correlators.

7. A method of operating a receiver comprising a plurality of antennas for receiving signals originally transmitted as a plurality of different signals, the method comprising applying a respective unique code to the signal received by each antenna, combining the plurality of coded signals into a single signal, translating the frequency of the single signal to a lower frequency and extracting a plurality of signals from the frequency-translated single signal by reference to the unique codes used to generate the coded signals.

8. A method as claimed in claim 7, characterised in that the respective unique codes are orthogonal codes.

9. A method as claimed in claim 8, characterised in that the respective unique codes are Walsh codes.

10. A method as claimed in claim 8 or 9, characterised in that the rate of the unique code is at least N times the symbol rate of the received signals, where N is equal to the number of antennas.

11. A method as claimed in any one of claims 7 to 10, characterised in that the extraction of the plurality of signals is performed using correlators.
